(19) United States
(12) Patent Application Publication
(10) Pub. No.: US 2008/0224989 A1
(43) Pub. Date: Sep. 18, 2008

(54) Electrophoretic Display and a Method and Apparatus for Driving an Electrophoretic Display

(75) Inventors: Guofu Zhou, Eindhoven (NL); Mark Thomas Johnson, Eindhoven (NL); Neculai Ailenei, Heerlen (NL); Johannes Petrus Van De Kamer, Heerlen (NL); Peter Alexander Duine, Eindhoven (NL); Anthonie Hendrik Bergman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,253

(22) PCT Filed: Jan. 7, 2005
(86) PCT No.: PCT/IB2005/050086

§ 371 Date: Jul. 18, 2006

(30) Foreign Application Priority Data
Jan. 22, 2004 (EP) 04100212.2

(51) Int. Cl. G09G 3/34

(52) U.S. Cl. 345/107

(57) ABSTRACT

An electrophoretic display, in which a driving method is employed whereby a sequence of discrete picture potential differences in the form of a driving waveform is supplied for enabling the charged particles (6) of the display to occupy a position for displaying an image, the position being one of a number of positions between the electrodes (3, 4). The driving waveform consists of a sequence of image update signals including a picture potential difference, the image update signals being separated by dwell times, and the method includes the step of generating one or more shaking pulses during the dwell times. Such shaking pulses may be generated immediately after each image update signal or they may comprise regular shaking pulses generated at predetermined intervals along the waveform.

This invention relates to an electrophoretic display comprising an electrophoretic material comprising charged particles in a fluid, a plurality of picture elements, first and second electrodes associated with each picture element for receiving a potential difference, the charged particles being able to occupy a position being one of a plurality of positions between the electrodes, and drive means arranged to supply a sequence of picture potential differences in the form of a driving waveform for enabling the charged particles to occupy one of the positions for displaying an image.

An electrophoretic display comprises an electrophoretic medium consisting of charged particles in a fluid, a plurality of picture elements (pixels) arranged in a matrix, first and second electrodes associated with each pixel, and a voltage driver for applying a potential difference to the electrodes of each pixel to cause it to occupy a position between the electrodes, depending on the value and duration of the applied potential difference, so as to display a picture.

In more detail, an electrophoretic display device is a matrix display with a matrix of pixels which area associated with intersections of crossing data electrodes and select electrodes. A grey level, or level of colourisation of a pixel, depends on the time a drive voltage of a particular level is present across the pixel. Dependent on the polarity of the drive voltage, the optical state of the pixel changes from its present optical state continuously towards one of the two limit situations, e.g. one type of all charged particles is near the top or near the bottom of the pixel. Grey scales are obtained by controlling the time the voltage is present across the pixel.

Usually, all of the pixels are selected line by line by supplying appropriate voltages to the select electrodes. The data is supplied in parallel via the data electrodes to the pixels associated with the selected line. If the display is an active matrix display, the select electrodes will activate active elements such as TFT's, MIM's, diodes, which in turn allow data to be supplied to the pixel. The time required to select all the pixels of the matrix display once is called the sub-frame period. A particular pixel either receives a positive drive voltage, a negative drive voltage, or a zero drive voltage during the whole sub-frame period, dependent on the change in optical state required to be effected. A zero drive voltage should be applied to a pixel if no change in optical state is required to be effected.

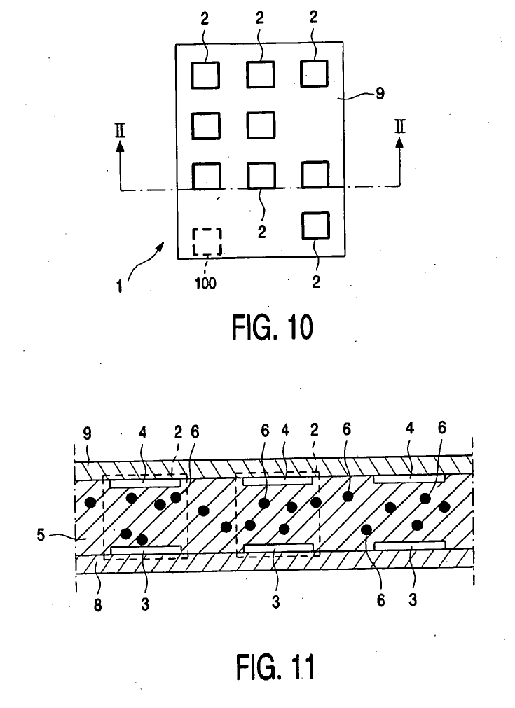

FIGS. 10 and 11 illustrate an exemplary embodiment of a display panel 1 having a first substrate 8, a second opposed substrate 9, and a plurality of picture elements 2. In one embodiment, the picture elements 2 might be arranged along substantially straight lines in a two-dimensional structure. In another embodiment, the picture elements 2 might be arranged in a honeycomb arrangement.

An electrophoretic medium 5, having charged particles 6 in a fluid, is present between the substrates 8, 9. A first and second electrode 3, 4 are associated with each picture element 2 for receiving a potential difference. In the arrangement illustrated in FIG. 11, the first substrate 8 has for each picture element 2 a first electrode 3, and the second substrate 9 has for each picture element 2 a second electrode 4. The charged particles 6 are able to occupy extreme positions near the electrodes 3, 4, and intermediate positions between the electrodes 3, 4. Each picture element 2 has an appearance determined by the position of the charged particles 6 between the electrodes 3, 4.

Electrophoretic media are known per se from, for example, U.S. Pat. No. 5,961,804, U.S. Pat. No. 6,120,839 and U.S. Pat. No. 6,130,774, and can be obtained from, for example, E Ink Corporation. As an example, the electrophoretic medium 5 might comprise negatively charged black particles 6 in a white fluid. When the charged particles 6 are in a first extreme position, i.e. near the first electrode 3, as a result of potential difference applied to the electrodes 3, 4 of, for example, 15 Volts, the appearance of the picture element 2 is for example, white in the case that the picture element 2 is observed from the side of the second substrate 9.

When the charged particles 6 are in a second extreme position, i.e. near the second electrode 4, as a result of a potential difference applied to the electrodes 3, 4 of, for example, −15 Volts, the appearance of the picture element is black. When the charged particles 6 are in one of the intermediate positions, i.e. between the electrodes 3, 4, the picture element 2 has one of a plurality of intermediate appearances, for example, light grey, mid-grey and dark grey, which are grey levels between black and white.

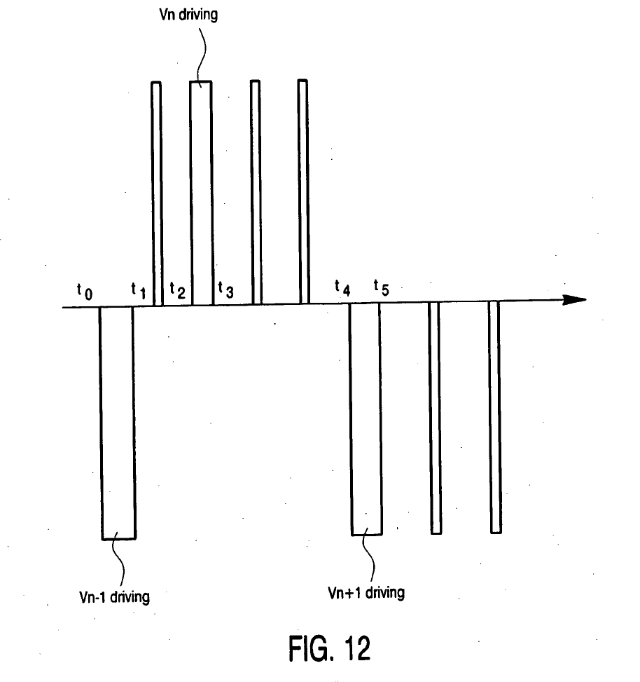

FIG. 12 illustrates part of a typical conventional random greyscale transition sequence using a pulse width modulated transition matrix. Between the image state n and the image state n+1, there is always a certain time period (dwell time) available which may be anything from a few seconds to a few minutes, dependent on different users.

In general, in order to generate grey scales (or intermediate colour states), a frame period is defined comprising a plurality of sub-frames, and the grey scales of an image can be reproduced by selecting per pixel during how many sub-frames the pixel should receive which drive voltage (positive, zero, or negative). Usually, the sub-frames are all of the same duration, but they can be selected to vary, if desired. In other words, typically grey scales are generated by using a fixed value drive voltage (positive, negative, or zero) and a variable duration of drive periods. Alternatively, variable drive voltages magnitudes could be applied to generate grey levels.

In a display using electrophoretic foil, many insulating layers are present between the ITO-electrodes, which layers become charged as a result of the potential differences. The charge present at the insulating layers is determined by the charge initially present at the insulating layers and the subsequent history of the potential differences. Therefore, the positions of the particles depend not only on the potential differences being applied, but also on the history of the potential differences. As a result, significant image retention can occur, and the pictures subsequently being displayed according to image data differ significantly from the pictures which represent an exact representation of the image data.

As stated above, grey levels in electrophoretic displays are generally created by applying voltage pulses for specified time periods. They are strongly influenced by image history, dwell time, temperature, humidity, lateral inhomogeneity of the electrophoretic foils, etc. In order to consider the complete history, driving schemes based on the transition matrix have been proposed. In such an arrangement, a matrix look-up table (LUT) is required, in which driving signals for a greyscale transition with different image history are predetermined. However, build up of remnant dc voltages after a pixel is driven from one grey level to another is unavoidable because the choice of the driving voltage level is generally based on the requirement for the grey value. The remnant dc voltages, especially after integration after multiple greyscale transitions, may result in severe image retention and shorten the life of the display.

It is therefore an object of the present invention to provide a method and apparatus which overcomes the problems outlined above, to reduce image retention in an electrophoretic display.

In accordance with the present invention, there is provided a display apparatus, comprising:
an electrophoretic material comprising charged particles in a fluid;
   a plurality of picture elements;
   first and second electrodes associated with each picture element for receiving a potential difference, said charged particles being able to occupy a position being one of a plurality of positions between said electrodes; and
   drive means arranged to supply a sequence of picture potential differences in the form of a driving waveform for enabling said charged particles to occupy one of said positions for displaying an image, the driving waveform consisting of a sequence of image update signals including a picture potential difference, the image update signals being separated by dwell times, wherein one or more shaking pulses are generated during the dwell times.

Also in accordance with the present invention, there is provided a method of driving a display apparatus, the apparatus comprising:
an electrophoretic material comprising charged particles in a fluid;
a plurality of picture elements;
first and second electrodes associated with each picture element for receiving a potential difference, said charged particles being able to occupy a position being one of a plurality of positions between said electrodes; and
drive means arranged to supply a sequence of picture potential differences in the form of a driving waveform for enabling said charged particles to occupy one of said positions for displaying an image, the driving waveform consisting of a sequence of image update signals including a picture potential difference, the image update signals being separated by dwell times; the method including the step of generating one or more shaking pulses during the dwell times.

Still further in accordance with the present invention, there is provided driving apparatus for driving a display apparatus, the display apparatus comprising:
an electrophoretic material comprising charged particles in a fluid;
a plurality of picture elements; and
first and second electrodes associated with each picture element for receiving a potential difference, said charged particles being able to occupy a position being one of a plurality of positions between said electrodes;
   wherein the driving apparatus is arranged to supply a sequence of picture potential differences in the form of a driving waveform for enabling said charged particles to occupy one of said positions for displaying an image, the driving waveform consisting of a sequence of image update signals including a picture potential difference, the image update signals being separated by dwell times, the driving apparatus further comprising means for generating one or more shaking pulses during the dwell times.

In one aspect, the one or more shaking pulses may be generated, preferably substantially immediately, following each image update signal.

Each image update signal preferably consists of a reset pulse and a greyscale driving pulse. One or more shaking pulses may also be generated as part of the image update signal, for example, between the reset pulse and the greyscale driving pulse and/or substantially immediately prior to the reset pulse, as part of the image sequence.

In one preferred embodiment of the invention, a sequence of shaking pulses may be generated following each image update signal, the energy of the shaking pulses, defined as the product of (voltage magnitude)×(time), of each sequence decreasing progressively during the sequence, such that the energy of the first few pulses of the sequence is greater than that of the final few pulses of the same sequence.

In accordance with a second aspect of the invention, the one or more shaking pulses may comprise regular shaking pulses, which may be generated at predetermined, preferably substantially equi-distant, intervals along the driving waveform.

Each image update signal may also be immediately preceded by one or more shaking pulses. Means may be provided to temporarily stop generation of the one or more regular shaking pulses during an image update sequence.

Charge recycling means may be provided so as to reduce power consumption. Alternatively, or in addition, the apparatus may be arranged to operate in one of at least two modes, a first mode in which generation of the regular shaking pulses is enabled and a second mode in which generation of the regular shaking pulses is disabled, such that power consumption is reduced in the second mode relative to that in the first.

The term “shaking pulses” is used herein to refer to as one short voltage pulse or a series of short, alternating negative and positive, voltage pulses. A shaking pulse is a single polarity voltage pulse representing an energy value sufficient to release particles at one of the two extreme positions but insufficient to move the particles from one of the extreme positions to the other extreme position between the two electrodes. When a single shaking pulse is used, its polarity is preferably opposite to the first pulse of the subsequent drive waveform.

These and other aspects of the invention will be apparent from, and elucidated with reference to, the embodiments described hereinafter.

Embodiments of the present invention will now be described by way of examples only and with reference to the accompanying drawings, in which:

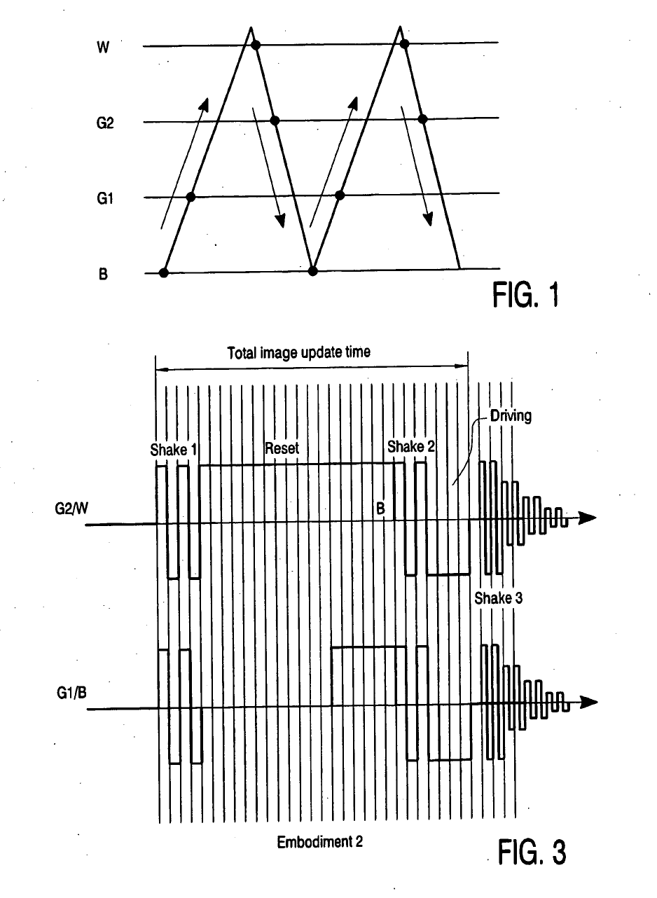

FIG. 1 illustrates schematically a cyclic rail-stabilized driving method for an electrophoretic display having four optical states: white (W), light grey (G2), dark grey (G1) and black (B);

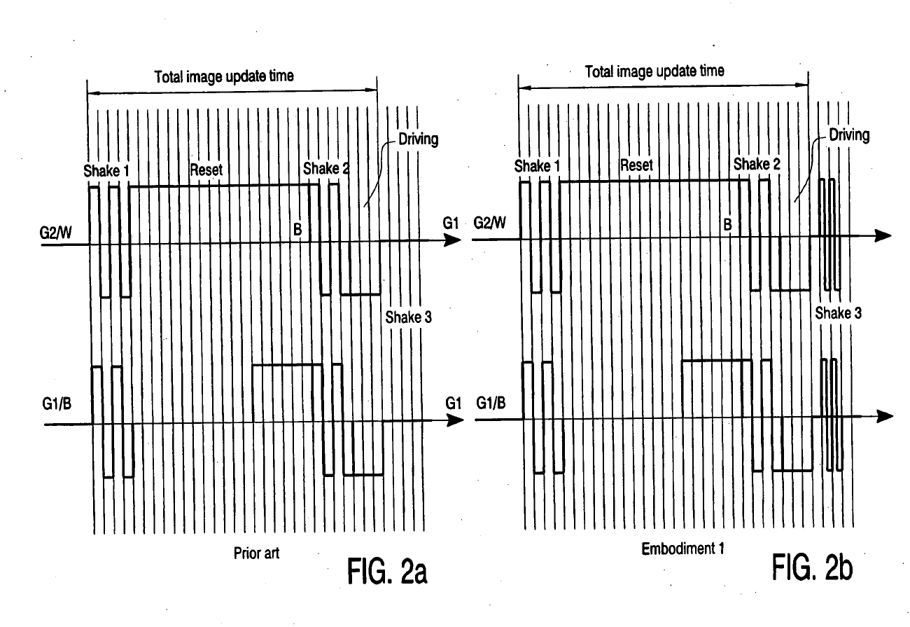

FIG. 2a illustrates schematically a driving waveform generated by a known method;

FIG. 2b illustrates schematically a driving waveform generated by a method according to a first exemplary embodiment of the present invention;

FIG. 3 illustrates schematically a driving waveform generated by a method according to a second exemplary embodiment of the present invention.

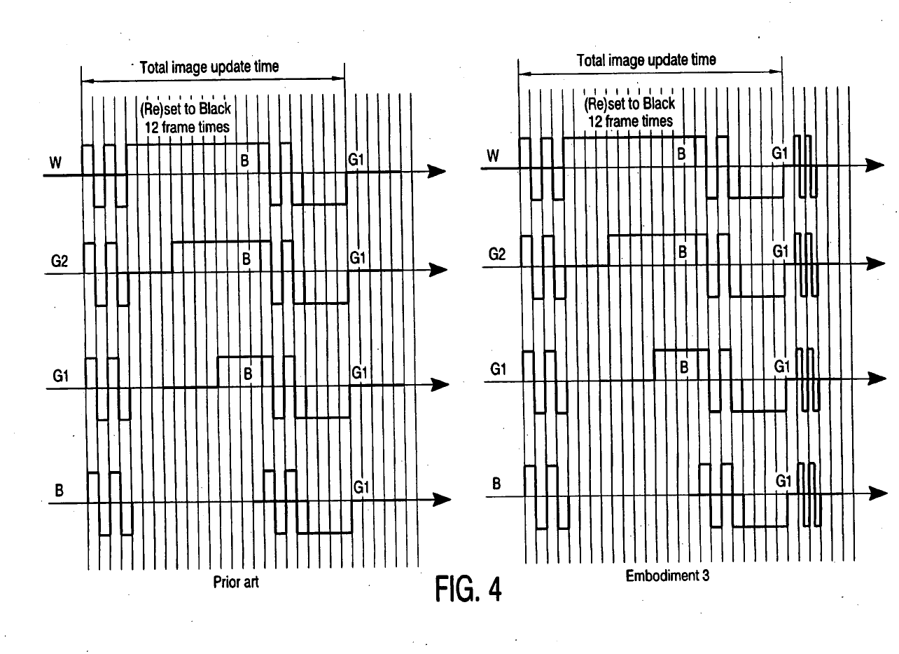

FIG. 4 illustrates schematically a driving waveform generated by a method according to a third exemplary embodiment of the present invention, in comparison with a driving waveform generated by a known method.

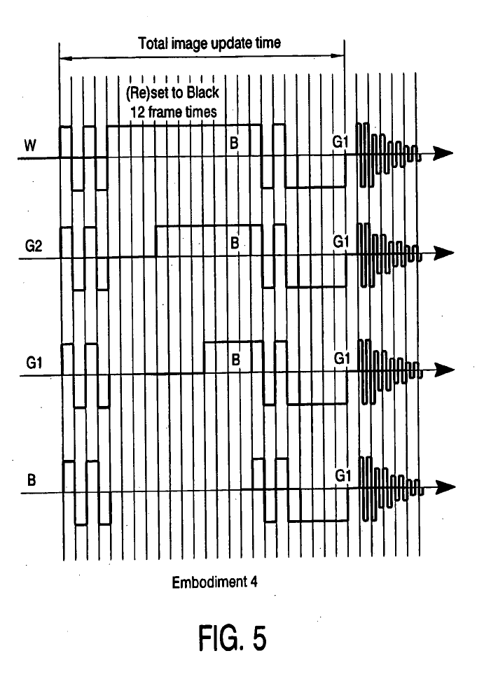

FIG. 5 illustrates schematically a driving waveform generated by a method according to a fourth exemplary embodiment of the present invention;

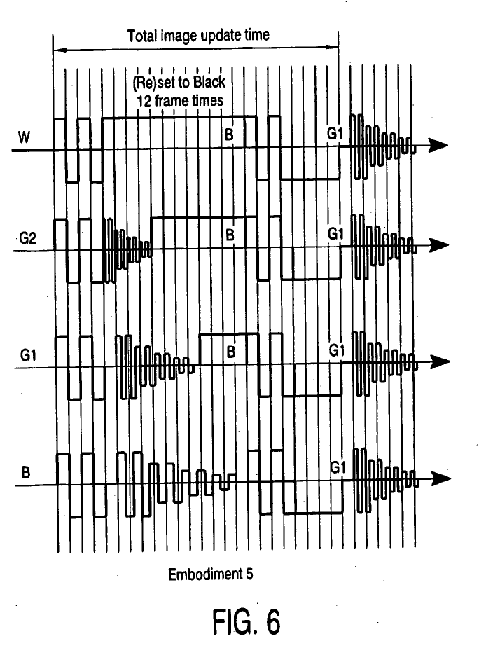

FIG. 6 illustrates schematically a driving waveform generated by a method according to a fifth exemplary embodiment of the present invention;

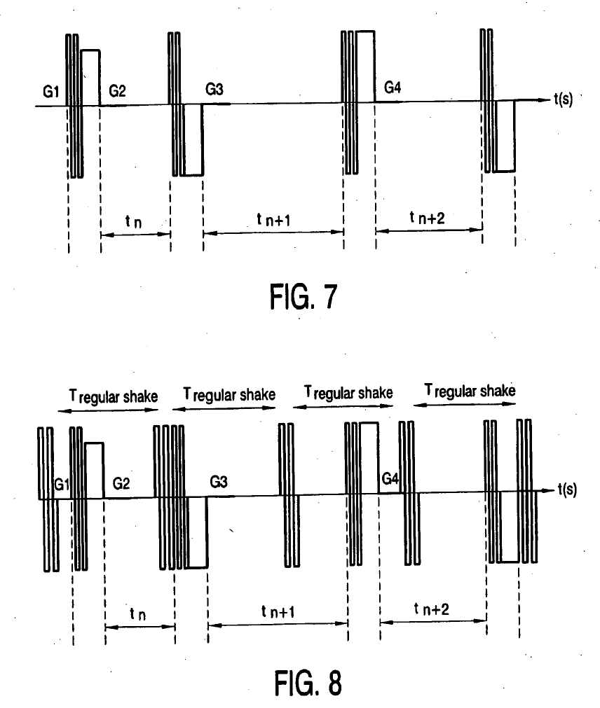

FIG. 7 illustrates schematically a driving waveform generated by a known method;.

FIG. 8 illustrates schematically a driving waveform generated by a method according to a sixth exemplary embodiment of the present invention;

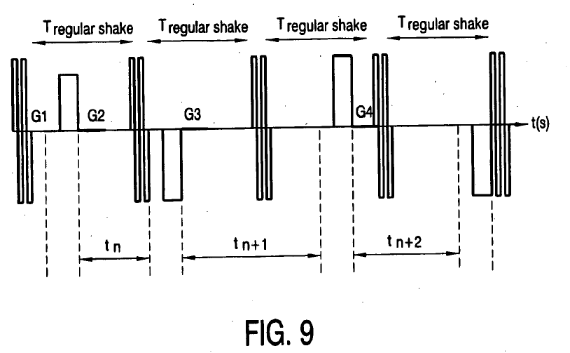

FIG. 9 illustrates schematically a driving waveform generated by a method according to a seventh exemplary embodiment of the present invention;

FIG. 10 is a schematic front view of a display panel according to an exemplary embodiment of the present invention;

FIG. 11 is a schematic cross-sectional view along II-II of FIG. 10; and

FIG. 12 illustrates part of a typical greyscale transition sequence using a voltage modulated transition matrix according to the prior art.

Thus, as explained in detail above, grey levels in an electrophoretic display are generally created by applying voltage pulses to the electrodes of the respective picture elements for specified time periods. The accuracy of the greyscales in electrophoretic displays is strongly influenced by image history, dwell time, temperature, humidity, lateral inhomogeneity of the electrophoretic foils, etc.

It has been demonstrated that accurate grey levels can be achieved using a so-called rail-stabilized approach. This means that the grey levels are always achieved via one of the two extreme optical states (say black or white) or “rails”, irrespective of the image sequence itself.

In order to achieve substantially dc-balanced driving, a cyclic rail-stabilized greyscale concept has recently been proposed, and it is illustrated schematically in FIG. 1 of the drawings. In this method, as stated above, the “ink” must always follow the same optical path between the two extreme optical states, say full black or full white (i.e. the two rails), regardless of the image sequence, as indicated by the arrows in FIG. 1. In the illustrated example, the display has four different states: black (B), dark grey (G1), light grey (G2) and white (W).

A driving method using a single over-reset voltage pulse has recently been proposed for driving an electrophoretic display, and is shown schematically in FIG. 2a for image transitions to dark grey from black (B), dark grey (G1), light grey (G2) and white (W). The pulse sequence usually consists of four portions: a first sequence of shaking pulses, a reset pulse, a second sequence of shaking pulses, and a greyscale driving pulse, whereby the second sequence of driving pulses occurs between the reset and greyscale driving pulses.

The reset pulse is longer than the minimum time required for switching the “ink” from full black or white to the opposite rail state, thereby ensuring that the previous image is fully erased during a new image update. Regardless of the image update sequence, both the first and second sequences of shaking pulses are required to reduce dwell time and image history effects, thereby reducing the image retention and increasing greyscale accuracy.

However, image retention may still be unacceptably visible if the image update time is limited to less than, say, 1 second and, although such image retention can be reduced by the provision of a longer reset pulse and/or more shaking pulses, this would obviously increase the image update time beyond the required level.

Thus, in accordance with a first aspect of the invention, a driving method is proposed an electrophoretic display having at least four greyscale levels (hereinafter referred to as “two bits greyscale”) in which shaking pulses are provided substantially immediately after each greyscale driving pulse. Thus, in the preferred method, the driving pulse sequence will still consist of four portions: a first sequence of shaking pulses, a reset pulse, a second sequence of shaking pulses (between the reset and greyscale driving pulses) and a greyscale driving pulse, as described with reference to FIG. 2a, but with the addition of a third sequence of shaking pulses during the dwell time immediately following the greyscale driving pulse. It will be apparent to a person skilled in the art that the energy involved in the third sequence of shaking pulses should be sufficient to move the particles a relatively small distance but insufficient to move the particles over any significant distance such that visible optical flicker is avoided.

The third sequence of shaking pulses are beneficially applied to the whole display at the same time by means of, for example, hardware shaking, where pixels are provided with voltage pulses independent of the image update sequence. In this way, image retention can be reduced without increasing the total image update time.

In more detail, and referring to FIG. 2b of the drawings, in an exemplary embodiment of the invention, an electrophoretic display has two rail states and at least two bits grey level, i.e. black (B), dark grey (G1), light grey (G2) and white (W). Four transitions to G1 state from W, G2, G1 and B are realised using two types of pulse sequences when the over-reset technique described above is used for resetting the display, with a long sequence being required for the transition from G2 to W or G1, and a shorter sequence being used for transitions from G1 or B to G1.

In the illustrated example, for all types of image transition, each sequence consists of five portions, the image update sequence comprising, as before, a first sequence of shaking pulses, a reset pulse, a second sequence of shaking pulses (between the reset and greyscale driving pulses), and a greyscale driving pulse, and a fifth portion, comprising a third sequence of shaking pulses which are generated after the completion of an image update, i.e. during the dwell time immediately following an image update. Thus, because image update time is influenced only by the first four portions of the sequence described above, it is not adversely affected by the addition of the third sequence of shaking pulses, as the effect of the shaking pulse should be invisible to the user. Thus, in summary, the embodiment described with reference to FIG. 2b of the drawings, results in a reduced image retention without increasing image update time (as the final set of shaking pulses are not very visible to a viewer).

It is important to limit the visibility of optical flickers which may be caused by the third sequence of shaking pulses, by properly controlling the pulse time or amplitude of a shaking pulse so that the energy involved is sufficient to move the particles a relatively small distance but insufficient to move the particles any significant distance.

In accordance with a second exemplary embodiment of the present invention, as illustrated schematically in FIG. 3, a third sequence of shaking pulses is generated immediately after an image update sequence, as in the exemplary embodiment described with reference to FIG. 2b, but in this case, this third sequence of shaking pulses has a variable amplitude or pulse length time, such that in this case, the energy involved in the initial pulses in a sequence is greater than that involved in the final pulses of the sequence. Thus, the exemplary embodiment of the invention described with reference to FIG. 3 of the drawings results in a reduced image retention without an increase in image update time (as the visibility of the final shaking pulse is still further reduced relative to that of the drive waveform illustrated in FIG. 2b, due to its decreasing energy).

In accordance with a third exemplary embodiment of the present invention, as illustrated schematically in FIG. 4 of the drawings (right-hand side), the length of the reset pulse used in each image update sequence may be variable and proportional to the distance over which the ink is required to move in the vertical direction in order to effect an image transition. By way of clarification, the comparable driving waveforms generated by a known driving method are illustrated in the left-hand drawing of FIG. 4.

As an example, consider the situation where, if the image update data is pulse width modulated (PWM), a full pulse width (FPW) is required to effect a transition from white to black, but only ⅔ FPW is required to effect a transition from G2 to black, and only ⅓ FPW is required to go from G1 to black. Thus, a full reset pulse is used in the image update sequence for the white to black transition, ⅔ of that pulse length is used in the image update sequence for the G2 to black transition, ⅓ of that pulse length is used in the image update sequence for the G1 to black transition, and no reset pulse is used for the black to G1 transition, i.e. no “over-reset” technique is used. These waveforms are usable when, for example, transition matrix-based methods are used, in which previous images are considered in the determination of the energy impulses (time×voltage) of pulses required for the next image. In addition, these waveforms are usable when the electrophoretic materials used in the display are insensitive to the image history and/or dwell time.

As shown, a third sequence of shaking pulses is added to the waveform during the dwell time immediately following the greyscale driving pulse (or complete image update sequence). As before, because image update time is influenced only by the image update sequence as described above with reference to the first exemplary embodiment of the invention, it is not adversely affected by the addition of the third sequence of shaking pulses during the dwell time immediately following the image update sequence.

Once again, it is important to limit the visibility of optical flickers which may be caused by the third sequence of shaking pulses, by properly controlling the pulse time or amplitude of a shaking pulse so that the energy involved is sufficient to move the particles a relatively small distance but insufficient to move the particles any significant distance. As before, the third sequence of shaking pulses may be beneficially applied to the whole display at the same time by means of, for example, hardware shaking, regardless of the image update sequence. In this way, image retention can be reduced without increasing the total image update time.

Referring to FIG. 5 of the drawings, a driving waveform generated by a fourth exemplary embodiment of the present invention is similar in many respects to that described with reference to, and illustrated schematically by, FIG. 4 of the drawings. However, in this case, a different type of shaking pulse is used as the third sequence of shaking pulses, whereby the amplitude or pulse length time decreases over the sequence, i.e. the energy involved in the initial pulses of the sequence is greater than that of the final pulses of the sequence, as described with reference to the second exemplary embodiment of the invention.

In fact, total image update time in respect of the embodiments of FIGS. 4 and 5 can be further reduced relative to the embodiments described with reference to FIGS. 2b and 3.

Referring to FIG. 6 of the drawings, a driving waveform generated by a fifth exemplary embodiment of the present invention is similar in many respects to that described with reference to, and illustrated schematically by FIG. 5. However, in this case, a fourth sequence of shaking pulses is generated during the time space between the first sequence of shaking pulses and the reset pulse. By using these additional shaking pulses, the effects of dwell time and/or image history may be further reduced, and the resulting image is of increased quality with further reduced image retention, compared with prior art methods. The fourth sequence of shaking pulses may have a different format to that of the first, second and third sequences of shaking pulses. As a result of this embodiment, the image retention can be further reduced.

In accordance with a second aspect of the present invention, another driving method is proposed. As will be apparent from the above description, the inclusion of shaking pulses in the driving waveform of an electrophoretic display is a preferred element of most, if not all, electrophoretic display driving methods (both voltage modulated and pulse width modulated). These shaking pulses increase the accuracy of greyscales, remove image retention, account for dwell time and, if performed correctly, are optically invisible to the user.

Whilst image quality is obviously a priority, there is also a need to minimise image update time, especially when changing from one greyscale image to another. Currently, image update times of 600-800 msec are achievable, depending on the precise details of the driving scheme employed. However, in all driving schemes, a significant proportion of the image update time is taken up by shaking, as shown, for example, in FIG. 7 of the drawings, in which a sequence of shaking pulses are applied during the image update sequence immediately prior to each greyscale driving pulse required to effect each greyscale transition. The shaking pulses in the illustrated waveform are an integral part of the image update sequences and should, ideally, be as long as possible, say at least 80 msec long and, more typically, around 160 msec, in order to achieve the best possible image quality. Thus, shaking creates a significant delay in the total image update time. In other words, in known systems, there is a trade off between image quality and image update times, because in order to reduce image update time shaking time must be reduced, which has an adverse effect on image quality.

Thus, in accordance with the second aspect of the invention, it is proposed to generate shaking pulses during the dwell times between each image update sequence at intervals along the driving waveform, regardless of the image update signals. In this manner, image quality can be significantly improved and/or image update time can be reduced. As explained above, the shaking can be made optically invisible to the user using, for example, short pulses, column inversion schemes, etc. When relatively short shaking pulses are used, data-independent shaking can be applied to the whole display without visible optical flicker.

In a first exemplary embodiment of the second aspect of the present invention, a set of shaking pulses are applied at regular intervals along the driving waveform, during the dwell times between image update sequences, regardless of the image update data signals, whilst the “driving” shaking pulses applied prior to the greyscale driving pulse, i.e. those which form part of the image update sequence as shown in FIG. 7, remain. This is schematically illustrated in FIG. 8 for representative driving waveforms for the four random greyscale transitions as shown in FIG. 7. It is also schematically demonstrated in FIG. 8, that the dwell times tₙ, tₙ₊₁, tₙ₊₂ after different greyscale transitions may be different from each other.

The additional, regular shaking pulses have the effect of reducing the influence of these dwell times, as well as increasing greyscale accuracy (i.e. image quality). The addition of these regular shaking pulses further improves image quality as the image retention is further reduced without increasing the total image update time, relative to the driving method described with reference to FIG. 7. In other words, the adverse effects caused by dwell time are reduced, and an increased grey level accuracy and reduced image retention are achieved.

These regular shaking pulses may be randomly positioned/timed with respect to the image update sequences, although a constant time period is preferred between two adjacent shaking pulse sequences, as denoted by t_{regular shake} in FIG. 8. Thus, the resultant shaking pulse sequences can occur before or after an image update sequence, and they may even, sometimes, fall within an image update sequence.

The greyscale accuracy is not sensitive to the timing of these regular shaking pulses because these pulses are generally symmetric and introduce essentially little, if any, optical disturbance, for example, if short pulses are used. In order to reduce the probability of the regular shaking having an adverse influence on greyscale accuracy, the regular shaking can be disabled while an image is being updated, and then enabled again after the image update has been completed.

In an alternative embodiment of the second aspect of the present invention, the additional set of regular shaking pulses may be applied to the display, regardless of the image update data signals, as in the embodiment described with reference to FIG. 8, whilst the “driving” shaking pulses applied prior to each greyscale driving pulse in the waveforms illustrated in FIGS. 7 and 8, are omitted, as illustrated schematically in FIG. 9 for representative driving waveforms for the four random greyscale transitions as shown in FIGS. 7 and 8.

Once again, the addition of the regular shaking pulses improves the image quality as the image retention can be reduced, (almost) without increasing the total image update time. Similarly, these regular shaking pulses may be randomly positioned/timed with respect to the image update sequences, although a constant time period is preferred between two adjacent shaking pulse sequences, as denoted by t_{regular shake} in FIG. 8. Thus, the resultant shaking pulse sequences can occur before or after an image update sequence, and they may even, sometimes, fall within an image update sequence.

The omission of the “driving” shaking pulses results in a shorter total image update time but the dwell effects may not be completely eliminated as the timing of the regular shaking pulses is generally not linked to the image update sequences. This can be overcome by using electrophoretic material with less of a dwell time dependence.

In one exemplary embodiment of the invention, the timing of the regular shaking pulses may be such that a large number of regular shaking pulses are applied along the driving waveforms, thereby further improving the image quality.

Thus, in summary, the application of regular shaking pulses to driving waveforms for electrophoretic displays, according to the second aspect of the invention, can significantly improve image quality and/or shorten image update time, although power consumption may be increased relative to prior art schemes. In order to overcome this problem, and reduce power consumption, any known charge recycling technique could be applied, particularly in respect of the regular shaking pulse function so as to reduce the power used to charge and discharge pixel electrodes during the shaking pulse cycling. Another option would be to provide multiple usage modes on the display device, for example, using a dedicated switch enabling the device to be switched between with and without regular shaking. For example, the regular shaking mode may be enabled when the device is connected to a network power supply, and disabled when the device is being used as a potable device and is, therefore, relying on its own internal power supply.

Note that the invention may be implemented in passive matrix as well as active matrix electrophoretic displays. Also, the invention is applicable to both single and multiple window displays, where, for example, a typewriter mode exists. This invention is also applicable to colour bi-stable displays. Also, the electrode structure is not limited. For example, a top/bottom electrode structure, honeycomb structure or other combined in-plane-switching and vertical switching may be used.

Embodiments of the present invention have been described above by way of example only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. Display apparatus (1), comprising:
an electrophoretic material (5) comprising charged particles (6) in a fluid;
a plurality of picture elements (2);
first and second electrodes (3, 4) associated with each picture element (2) for receiving a potential difference, said charged particles (6) being able to occupy a position being one of a plurality of positions between said electrodes (3, 4); and
drive means arranged to supply a sequence of picture potential differences in the form of a driving waveform for enabling said charged particles (6) to occupy one of said positions for displaying an image, the driving waveform consisting of a sequence of image update signals including a picture potential difference, the image update signals being separated by dwell times, wherein one or more shaking pulses are generated during the dwell times.

2. Display apparatus (1) according to claim 1, wherein said one or more shaking pulses are generated following each image update signal.

3. Display apparatus (1) according to claim 2, wherein said one or more shaking pulses are generated substantially immediately following each image update signal.

4. Display apparatus (1) according to claim 2, wherein each image update signal comprises a reset pulse and a greyscale driving pulse.

5. Display apparatus (1) according to claim 4, wherein each image update signal includes one or more shaking pulses.

6. Display apparatus (1) according to claim 5, wherein one or more shaking pulses are provided prior to the reset pulse of each image update signal.

7. Display apparatus (1) according to claim 6, wherein one or more shaking pulses are provided between the reset pulse and the greyscale driving pulse of each image update signal.

8. Display apparatus (1) according to claim 2, wherein a sequence of shaking pulses is generated following each image update signal, the energy of the shaking pulses of each sequence decreasing progressively during said sequence.

9. Display apparatus (1) according to claim 1, wherein said one or more shaking pulses comprise regular shaking pulses which are generated at predetermined intervals along said driving waveform.

10. Display apparatus (1) according to claim 9, wherein said intervals are substantially equi-distant.

11. Display apparatus (1) according to claim 9, further including charge recycling means within a power supply used to generate said regular shaking pulses.

12. Display apparatus (1) according to claim 9, comprising means for temporarily preventing said regular shaking pulses from being generated during an image update sequence, and recommencing generation of said regular shaking pulses after the image update sequence has been completed.

13. Display apparatus (1) according to claim 9, arranged and configured to operate in one of at least two modes, and further including means for switching between said two modes.

14. Display apparatus (1) according to claim 13, arranged and configured to operate in one of a first mode, in which generation of said regular shaking pulses is enabled, and a second mode, in which generation of said regular shaking pulses is disabled.

15. A method of driving a display apparatus (1), the apparatus comprising:
an electrophoretic material (5) comprising charged particles (6) in a fluid;
a plurality of picture elements (2);
first and second electrodes (3, 4) associated with each picture element (2) for receiving a potential difference, said charged particles (6) being able to occupy a position being one of a plurality of positions between said electrodes (3, 4); and
drive means arranged to supply a sequence of picture potential differences in the form of a driving waveform for enabling said charged particles (6) to occupy one of said positions for displaying an image, the driving waveform consisting of a sequence of image update signals including a picture potential difference, the image update signals being separated by dwell times;
the method including the step of generating one or more shaking pulses during the dwell times.

16. Driving apparatus for driving a display apparatus (1), the display apparatus comprising:
an electrophoretic (5) material comprising charged particles (2) in a fluid;
a plurality of picture elements (2);
first and second electrodes (3, 4) associated with each picture element (2) for receiving a potential difference, said charged particles being able to occupy a position being one of a plurality of positions between said electrodes (3, 4); and
wherein the driving apparatus is arranged to supply a sequence of picture potential differences in the form of a driving waveform for enabling said charged particles (6) to occupy one of said positions for displaying an image, the driving waveform consisting of a sequence of image update signals including a picture potential difference, the image update signals being separated by dwell times, the driving apparatus further comprising means for generating one or more shaking pulses during the dwell times.
